(19) United States
(12) Patent Application Publication
(10) Pub. No.: US 2002/0003454 A1
(43) Pub. Date: Jan. 10, 2002

(54) BALUN ASSEMBLY WITH RELIABLE COAXIAL CONNECTION

(76) Inventors: RICHAEL EMIL SWEENEY, DRACUT, MA (US); GLEN BRIAN ROCHFORD, PELHAM, NH (US)

Correspondence Address: THE WHITAKER CORPORATION, 4550 NEW LINDEN HILL ROAD, WILMINGTON, DE, 198082952

(21) Appl. No.: 09/213,183

(22) Filed: Dec. 17, 1998

(51) Int. Cl. H01P 5/10

(52) U.S. Cl. 333/26; 333/33

(57) ABSTRACT

A Balun assembly has a signal conductor (2) on the balanced side of a Balun, the signal conductor (2) being joined to a microstrip RF launch area 7 on a circuit board 6, the signal conductor (2) having a bend of axial orientation for lower cost, reliability, avoiding contact with a ground circuit path (9), being more suited for higher volume manufacturing, that distributes thermal expansion and contraction thereof substantially throughout to lessen stress at a junction of the signal conductor (2) and the RF launch area (7), and the signal conductor (2) being of minimum length and of smooth and even curvature to lessen impedance mismatch at the junction.

### FIELD OF THE INVENTION

The invention relates to a Balun assembly having a coaxial cable, and, more particularly to a more reliable, easily manufactured and electrically repeatable Balun assembly. Balun assemblies have a coaxial cable to join with an RF, radio frequency, launch area on a circuit board.

### BACKGROUND OF THE INVENTION

A known Balun assembly is a three port device having one 50 ohm impedance and two 25 ohm impedance ports. When used on a push pull RF device with 25 ohm matching structures (two inputs and two outputs), a Balun at the input will be needed as a splitter (50 ohms input to two 25 ohm outputs) feeding the RF device. And at the output of the two 25 ohm matching structures, the Balun is used as a combiner (two 25 ohm inputs and one 50 ohm output.) On the combiner configuration, unbalanced side of the Balun assembly (the two 25 ohm ports), the coaxial cable ground shield connects one of the 25 ohm ports, by solder joint, to an RF launch area for RF signals. Then that ground shield traverses along a curved ground circuit path on a circuit board to the balanced side, and is connected to ground at the balanced side. That ground shield is continuously soldered to the circuit board trace. Further, a signal conductor of the coaxial cable projects outwardly from the unbalanced side to the second 25 ohm port and joins, by a solder joint, with an RF launch area for RF signals. The same, second 25 ohm RF launch area is connected with a second, RF trace of equal electrical length, as the coaxial shield trace and is routed separately to a common, i.e. shared, balanced side ground. The signal conductor of the remainder of the coaxial cable joins, by a solder joint, with the balanced RF launch area for RF signals. The RF launch area is defined by a 50 ohm microstrip circuit trace on the circuit board at the RF output.

The known Balun assembly is provided on both sides of a known bidirectional, push-pull circuit. Both sides of the known push-pull circuit have respective RF inputs, and both sides are coupled by a respective Balun assembly to a single RF output. For example, the respective Balun assembly extracts unbalanced RF input signals from the two 25 ohm inputs characteristic impedance, and provides an RF output signal of 50 Ohms characteristic impedance at the launch area at the RF output. The balanced side and the unbalanced side of the respective Balun assembly have different characteristic impedances. Further the unbalanced side outer conductor and signal conductor are intended to have RF signals 180 degrees out of phase, due to the conservation of charge. By adjusting their physical dimensions, for example, their dimensional lengths, assures proper match at respective RF signals.

The respective Balun assembly comprises a balanced side having a microstrip transmission line of known construction. A portion of the microstrip transmission line comprises a curved circuit path on a surface of a circuit board of known construction. An unbalanced side of the respective Balun assembly is constructed, in part, as having a coaxial cable, for example, of 50 Ohms characteristic impedance. A shield conductor of the coaxial cable is collinear with a curved ground circuit path on the same surface of the circuit board.

On the circuit board, the curved circuit paths of the of the balanced and unbalanced sides of a respective Balun assembly are curved, reversely back on themselves, along their lengths to attain compactness in size. Further, the curved circuit paths of the respective Balun assembly are symmetrical. Therein lies a problem, that the curved circuit paths are shaped primarily to attain their symmetry and compactness in size. However, the curved ground circuit path constrains the coaxial cable to extend along the curved circuit path, and the exposed signal conductor of the coaxial cable is exposed at length from the shield conductor, which contributes to undesired impedance mismatch. Further, the exposed signal conductor must be shaped by bending to fit with the geometry of the Balun assembly on the circuit board. For example, the exposed signal conductor is shaped by bending to extend toward, and to join with, the RF launch area.

Because the exposed signal conductor must be shaped to fit the geometry of the Balun assembly, and be bent and joined to a perpendicular RF launch. A sharp bend of less than minimum radii is normally incorporated. The expanding dielectric over temperature cycles pushes on the exposed bent section, which contributes unduly to stress concentration of the signal conductor at the Balun assembly. Stress concentration in the signal conductor leads to undesired fracture of a solder joint between the signal conductor and the RF launch area, as the Balun assembly is exposed to changing environmental temperatures over the passage of time.

Further, Because the exposed signal conductor must be shaped to fit the geometry of the Balun assembly, a bent and lengthy signal conductor results, which contributes unduly to impedance mismatch. For example, the exposed signal conductor contributes to impedance mismatch, for which impedance compensation is required to rectify undesired VSWR, voltage standard wave reflection due to the severity of the impedance mismatch. The exposed length and unevenness of bend of the exposed signal conductor contributes to the severity of impedance mismatch, and increases the difficulty in providing the required impedance compensation.

Prior to the invention, fabrication of the known Balun assembly required shaping of the coaxial cable to fit with undesirable, predetermined locations of both the ground circuit path and the RF launch area on the circuit board, which contributed undue mechanical stress and undesired impedance mismatch at a junction of the coaxial cable and the RF launch area.

### SUMMARY OF THE INVENTION

According to the invention, a Balun assembly has a coaxial cable that has a precise electrical length, an exposed signal conductor of the coaxial cable is of minimum length and of smooth and even curvature, by way of substantially straight portions of minimum length adjoining a portion of substantially smooth and even curvature and of minimum length, the signal conductor distributes thermal expansion and contraction thereof substantially throughout the portions of minimum length and the portion of substantially smooth and even curvature, and the signal conductor of minimum length and of smooth and even curvature lessens impedance mismatch.

An advantage of the invention resides in providing a Balun assembly of improved reliability and construction, and lessened VSWR.

A further advantage of the invention resides in a method of making a Balun assembly having an exposed signal conductor that contributes to lessened impedance mismatch, and distributes thermal expansion and contraction therealong to reduce stress concentration.

Further, according to the invention, a method of making a Balun assembly comprises the steps of, sizing a coaxial cable to a precise electrical length, shaping an exposed signal conductor that projects from a remainder of the coaxial cable with a portion of substantially smooth and even curvature and of minimum length, to project an end of the signal conductor substantially straight toward an RF launch area defined by a microstrip area on a circuit board, and positioning the RF launch area on the circuit board so as to be directly opposite the remainder of the cable and in close proximity thereto to minimize the length of the exposed signal conductor, thereby contributing to lessened impedance mismatch, and thereby distributing thermal expansion and contraction along the portion of substantially smooth and even curvature to reduce strain on the joint.

A further advantage of the invention resides in a method of making a Balun assembly having an exposed signal conductor that contributes to lessened impedance mismatch, and that distributes thermal expansion and contraction therealong to reduce stress concentration.

### DESCRIPTION OF THE DRAWINGS

An embodiment of the invention will now be described by way of example with reference to the accompanying drawings, according to which:

FIG. 1 is a top view of a coaxial cable of precise electrical length, with an exposed signal conductor of the coaxial cable projecting from a remainder of the coaxial cable, the signal conductor having a distinctive shape;

FIG. 2 is a side view of the coaxial cable, as shown in FIG. 1;

FIG. 3 is a fragmentary side view of an exposed signal conductor prior to shaping the exposed signal conductor to its distinctive shape, as shown in FIG. 1;

FIG. 4 is a fragmentary top view of a circuit board and a portion of a Balun assembly having a desired geometry;

FIG. 5 is a fragmentary top view of the structure, as shown in FIG. 5, together with the coaxial cable, as shown in FIG. 1;

FIG. 6 is a fragmentary side view of the structure, as shown in FIG. 5;

FIG. 7 is a fragmentary top view of circuit board and a portion of a Balun assembly having an undesired geometry; and

FIG. 8 is a fragmentary top view of the structure, as shown in FIG. 7, together with a coaxial cable of undesired geometry.

### DETAILED DESCRIPTION

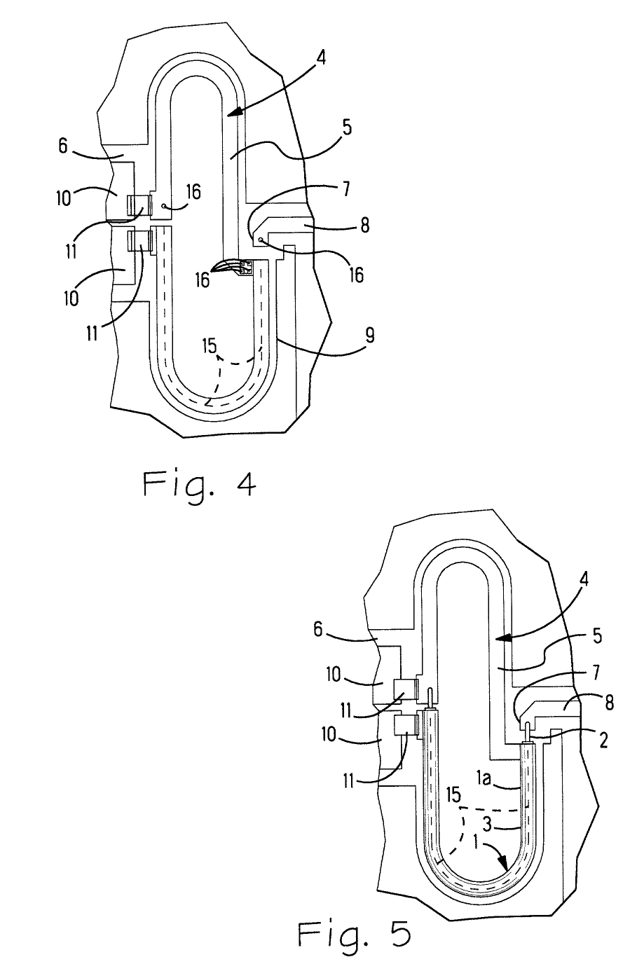

With reference to FIG. 1, a coaxial cable 1 has an axial signal conductor 2 and a concentric ground shield 3. A concentric dielectric material 4 is between the signal conductor 2 and the ground shield 3. The coaxial cable 1 has a known characteristic impedance, for example, 50 Ohms characteristic impedance. The coaxial cable 1 is a part of a Balun assembly 4 that is shown, in part, in FIG. 4. For the purpose of describing the invention, only portions of the Balun assembly 4 are disclosed. Accordingly, with reference to FIG. 4, a balanced side of the Balun assembly 4 has a curved microstrip transmission line 5 on a circuit board 6 connected to an RF launch area 7 at an RF output 8 that is shown as a microstrip circuit path. The RF launch area 7 is defined by a microstrip area on the circuit board 6.

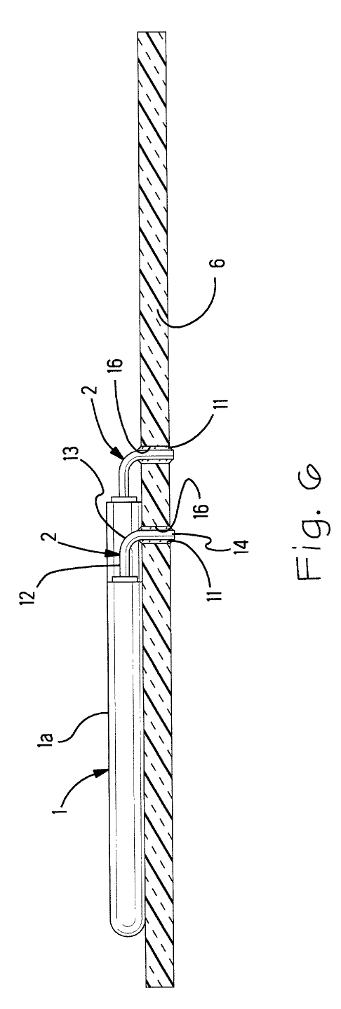

An unbalanced side of the Balun assembly 4 includes a curved ground circuit path 9 on the circuit board 6 to which the ground shield 3 of the coaxial cable 1 is to be joined, as shown in FIG. 5. Two RF inputs 10 are defined by microstrip areas on the circuit board 6. The two RF inputs 10 are coupled to the Balun assembly 4 by respective DC blocking capacitors 11.

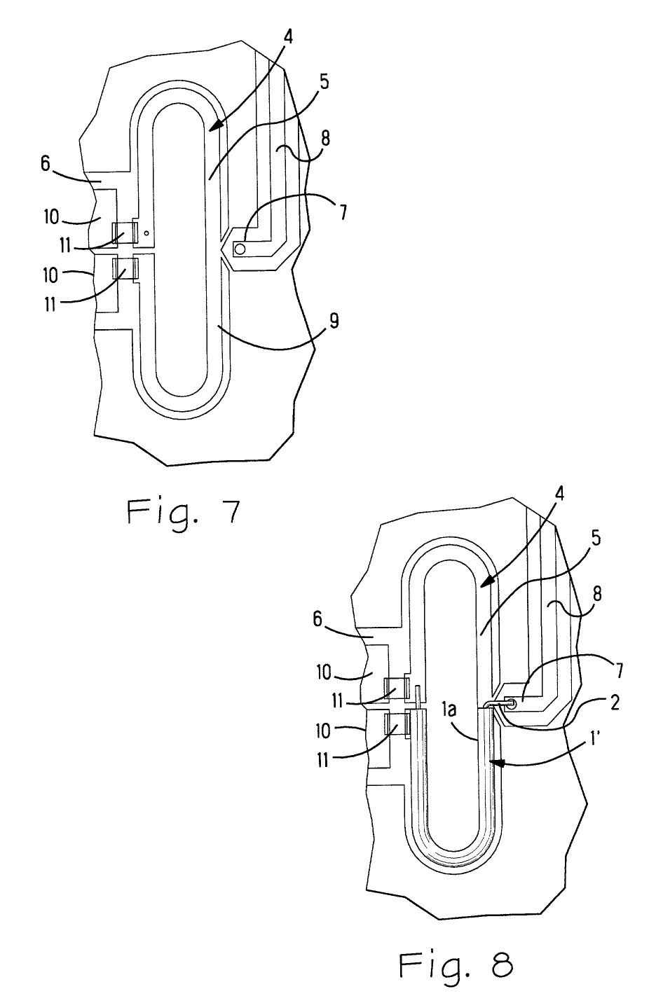

With reference to FIG. 7, a Balun assembly 4 of different geometry is shown. In FIG. 7, the microstrip transmission line 5 of the respective Balun assembly 4 is curved, reversely back on itself, along its length to attain compactness in size. Further, the ground circuit path 9 of the Balun assembly 4 is curved to attain compactness in size and to attain symmetry with the microstrip transmission line 5.

With reference to FIG. 8, another coaxial cable 1′, similar to the coaxial cable 1, as shown in FIG. 1, is fabricated to a desired physical length that will transmit RF signals, and that will launch such RF signals of a desired phase, or desired phase angle, at the rf launch area 7 having a geometry, as shown in FIGS. 7 and 8, that differs from the geometry as shown in FIGS. 4 and 5. Said another coaxial cable 1′ is then shaped to fit with the geometry of the Balun assembly 4 on the circuit board 6 that is shown in FIG. 7. Thereby, the coaxial cable 11 is constrained to extend along the symmetrical curve of the ground circuit path 9. Further the exposed signal conductor 2 is bent to extend to the RF launch area 7. It has been observed that the curved ground circuit path 9 of FIGS. 7 and 8, and the RF launch area 7 has an undesirable geometry. The undesirable geometry results in the following disadvantages:

A. The exposed signal conductor 2 of the coaxial cable 1′ is exposed at length from the remainder 1a of the coaxial cable 1′, which contributes to undesired impedance mismatch. To maintain minimum bend radii of the center conductor and launch to the trace 7, the length is reflective to RF signals.

B. Physical connection “shorting-out” between the signal conductor and the shielding is a common manufacturing problem.

C. Further, the exposed signal conductor 2 must be shaped by bending to a dual axis bend to fit with the undesirable geometry of the Balun assembly 4 on the circuit board 6. It is cost prohibitive, both, to make the dual two axis bend, and to preserve that bend to the manufacturing floor prior to installation. For example, the concentric shield of the coaxial cable 1′ is bent to follow along the curved ground circuit path 9 of the Balun assembly 4. The exposed signal conductor 2 of the coaxial cable 1′ is fabricated by bending, to extend toward, and to join with, the RF launch area 7 by way of a solder joint.

With continuing reference to FIGS. 7 and 8, an unbalanced condition of the Balun assembly will now be described. The exposed signal conductor 2 emerges from the shield on a remainder of the coaxial cable, and extends over the ground circuit path 9, and is curved to one side of the ground circuit path 9. Because the shield on the coaxial cable is shortened relative to the exposed signal conductor 2, an offset is created, which makes the two legs of the Balun assembly unbalanced, e.g., ground currents of the ground circuit path 9 are influenced by the offset.

This part of the exposed signal conductor 2 has a minimum length of πD/4, where D is the overall diameter of the coaxial cable. Further, the exposed signal conductor 2 spans a gap between the RF launch area 7 and one side of the ground circuit path 9 of the Balun assembly 4. The standard practice is to dimension the gap the same, more or less, to the line width of the launch area 7, although reducing the gap size is better. The signal conductor 2, after extending across the gap, further extends a distance to the junction with the launch area, for example, a distance of ½ the line width, according to standard practice. The length of the exposed signal conductor 2 extends in multiple planes, and the overall length and shape are uncertain, and difficult to repeat and maintain in a manufacturing environment.

Because the exposed signal conductor 2 must be shaped to fit the geometry of the ground circuit path 9 and the RF launch area 7, abrupt and uneven bends are shaped in the signal conductor 2, which create locations for stress concentration in the signal conductor 2, during thermal expansion and contraction of the signal conductor 2, as the known Balun assembly 4 is exposed to changing environmental temperatures. Exposure to environmental temperatures over time will cause undesired fracture of a solder joint between the signal conductor 2 and the RF launch area 7.

Further, the exposed signal conductor 2 comprises an unshielded signal transmission line that has characteristic impedance that differs significantly from the desired characteristic impedance of the remainder 1a of the coaxial cable 1′. The exposed signal conductor 2 contributes to impedance mismatch, for which impedance compensation is required to rectify undesired VSWR. The exposed length and unevenness of bend of the exposed signal conductor 2 contributes to impedance mismatch, and increases the difficulty in providing the required impedance compensation.

Prior to the invention, the Balun assembly 4 of undesirable geometry, FIG. 7, required a process to be performed, of shaping of the coaxial cable 1′ to fit with predetermined locations of both the ground circuit path 9 and the RF launch area 7 on the circuit board 6, which contributed to undue mechanical stress and undesired impedance mismatch at the juncture of the coaxial cable 1′ and the RF launch area 7. These disadvantages are overcome by the invention.

With reference to FIG. 1, a coaxial cable 1 to join with an RF launch area 7 on a circuit board 6 will be described. The coaxial cable 1 is fabricated to a desired physical length that will transmit and launch RF signals of a desired phase, or phase angle. Further, a signal conductor 2 of the coaxial cable 1 projects outwardly from a remainder 1a of the coaxial cable 1, and joins, by a solder joint 11, with an RF launch area 7, as shown in FIG. 6.

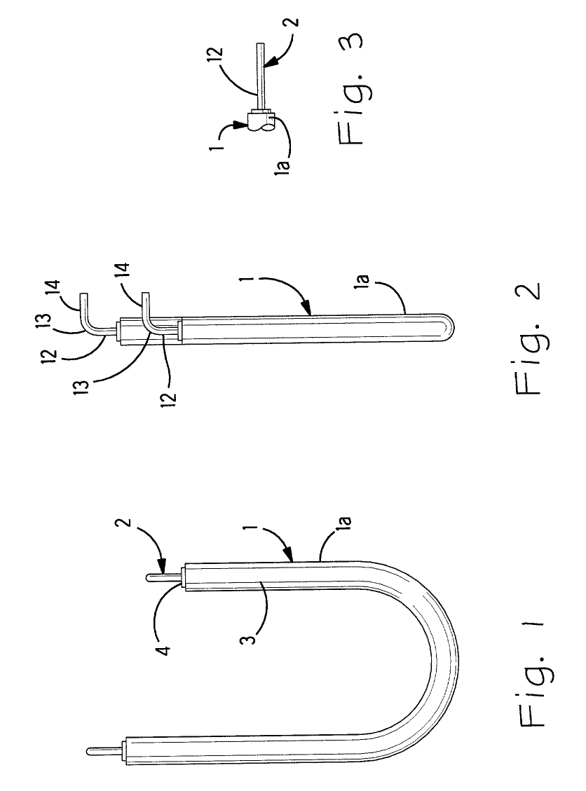

Further described with reference to FIG. 1, is a method of making the Balun assembly 4 as shown in FIGS. 4 and 5. A method of making the Balun assembly 4 comprises the steps of, shaping an exposed signal conductor 2 that projects from a remainder 1a of the coaxial cable 1 to extend a substantially smoothly and evenly straight portion 12 along a straight line that is coplanar with an axis of the cable 1, as shown in FIG. 3, and shaping an end portion 13 of the signal conductor 2 to extend substantially smoothly and evenly curved along a plane substantially perpendicular to the axis of the cable 1, as shown in FIG. 2, so as to extend a straight end 14 of the signal conductor 2 substantially perpendicular to the straight line, as shown in FIG. 2, and substantially straight toward the circuit board 6. The length of the exposed signal conductor 2 need not exceed πD/4, where D is the overall diameter of the coaxial cable 2. Further, the signal conductor 2 extends in a single plane, as contrasted to the dual plane bend of the undesired geometry, discussed with reference to FIGS. 7 and 8. Further, an imbalance of the two legs of the Balun assembly is avoided, by having the shield of the coaxial cable extending fully with the signal conductor 2 along the ground circuit path 9.

This process provides a signal conductor 2 of minimum length and free of abrupt bends, which contributes lessened impedance mismatch and distributes thermal expansion and contraction of the exposed signal conductor 2 substantially along the substantially straight portions 12, 14 and along the smoothly and evenly curved end portion 13 to lessen stress concentration at the joint 11 between the signal conductor 2 and the RF launch area 7. Thus, the signal conductor 2 has the desired shape, as shown in FIG. 2. The remainder 1a of the coaxial cable 1 can be formed with a smooth and even curvature to extend along a curved path. It is noted that the signal conductor 2 is formed with similar shapes at opposite ends thereof.

The coaxial cable 1 that has the signal conductor 2 of desired shape, as shown in FIG. 2, would be unable to fit the geometry of the Balun assembly 4 as shown in FIG. 7. As before described, shaping the coaxial cable 1′ to fit the undesirable geometry of the circuit as shown in FIG. 7, results in disadvantages. These disadvantages are avoided by the invention, as described with reference to FIG. 5.

With reference to FIG. 5, a desirable geometry of the Balun assembly 4 is provided by a method step of positioning the RF launch area 7 on the circuit board 6 to intercept and underlie the end 14 of the signal conductor 2 of the coaxial cable 1, as shown in FIG. 1. The exposed signal conductor 2 projects substantially straight from the remainder 1a of the cable 1, as shown in FIG. 3, which projects the center conductor to a position that overlies the RF launch area 7.

With reference to FIG. 5, the RF launch area 7 is positioned on the circuit board 6 in axial alignment with the curved path 15 of the remainder 1a of the coaxial cable 1. Further, with reference to FIG. 5, the RF launch area 7 is positioned directly opposite the remainder 1a of the cable 1 and in close proximity thereto to minimize the length of the exposed signal conductor 2, thereby contributing to lessened impedance mismatch, and thereby distributing thermal expansion and contraction along the substantially straight portions 12, 14 and along the portion of substantially smooth and even curvature to reduce strain on the joint 11.

Further with reference to FIG. 4, the method of making the Balun assembly 4 will continue to be described. The ground circuit path 9 is provided by a method step of positioning the ground circuit path 9 of the circuit board 6 along a curved path 15, as shown by an imaginary, dotted line in FIG. 4. The remainder 1a of the coaxial cable 1, as shown in FIG. 1, is formed with a smooth and even curvature to extend along the curved path 15. The length and shape of the ground circuit path 9, according to a desirable geometry, as shown in FIG. 4, conforms to the precise electrical length of the coaxial cable 1 that is described with reference to FIG. 1. Thereby, the curved path 15 of the ground circuit path 9, shown in FIG. 4, disregards a need for physical symmetry (still needs electrical length symmetry) with the curved microstrip transmission line 5, as shown in FIG. 4. The method of making the Balun assembly 4 further comprises, the step of positioning the RF launch area 7 in axial alignment with the curved path 15 of the ground circuit path 9, and further, the step of positioning the RF launch area 7 directly opposite, and in close proximity to an end of the ground circuit path 9. Thereby, the length of the exposed signal conductor 2 is reduced to a minimum to lessen undesired VSWR and to limit the length that is subject to thermal expansion and contraction.

According to the invention, a Balun assembly 4 has a coaxial cable 1 that is provided with a precise electrical length, an exposed signal conductor 2 of the coaxial cable 1 projects from a remainder 1a of the coaxial cable 1 and substantially evenly along a straight line that is coplanar with an axis of the cable 1, and an end part of the signal conductor 2 is substantially smoothly and evenly curved along a plane substantially perpendicular to the axis of the cable 1, so as to extend an end 14 of the signal conductor 2 substantially perpendicular to the straight line and substantially straight toward an RF launch area 7 defined by a microstrip area on a circuit board 6, whereby impedance mismatch is substantially reduced, and whereby the signal conductor 2 distributes thermal expansion and contraction along its substantially straight parts and along the smoothly and evenly curved end part of minimum length, to reduce strain on the joint 11.

With reference to FIG. 5, the remainder 1a of the coaxial cable 1 is shaped to extend along a curved path 15 in a flat plane, the RF launch area 7 is in axial alignment with the curved path 15, the end 14 of the signal conductor 2 overlies the RF launch area 7 and is joined thereto by a solder joint 11. For example, the end 14 of the signal conductor 2 projects through a via 16. The via 16 is an opening through the circuit board 6 that is lined with metal plating. The end 14 of the signal conductor 2 is joined by a solder joint 11 to the metal plating.

As shown in FIG. 2, the opposite end 14 of the signal conductor 2 is joined by a solder joint 11 to a similar via 16 that extends through the microstrip transmission line 5. The shield conductor of the coaxial cable 1 is joined by a solder joint 11, FIG. 2, to the curved ground circuit path 9. With reference to FIG. 4, a group of four vias 16 connect the ground circuit path 9 through the circuit board 6, and to an opposite side of the circuit board 6.

The RF launch area 7 is positioned on the circuit board 6 so as to be directly opposite the remainder 1a of the cable 1 and in close proximity thereto to minimize the length of the exposed signal conductor 2.

Accordingly, as part of a Balun assembly 4, a coaxial cable 1 has a precise electrical length, a signal conductor 2 projects outwardly beyond a remainder 1a of the coaxial cable 1 and substantially evenly along a straight line that is coplanar with an axis of the cable 1, an end part of the signal conductor 2 is substantially smoothly and evenly curved to extend an end 14 of the signal conductor 2 substantially perpendicular to the straight line, a ground circuit path 9 on a circuit board 6 is provided along a curved path 15 to be joined to a ground shield 3 of the coaxial cable 1, an RF launch area 7 defined by a microstrip area on the circuit board 6 is positioned in axial alignment with the curved path 15 and directly opposite an end 14 of the ground circuit path 9, the remainder 1a of the coaxial cable 1 is shaped with a smooth and even curvature to extend along the curved path 15, and the end 14 of the signal conductor 2 intercepts the RF launch area 7 and is joined thereto by a solder joint 11, whereby thermal expansion and contraction of the signal conductor 2 along the straight line and along the smoothly and evenly curved end part reduces strain on the joint 11 and lessens impedance mismatch for which impedance compensation would be required.

At the balanced end, the signal conductor 2 that is bent at the axial orientation is lower cost, as compared to a complex bend, provides a reliable connection that will not contact the ground circuit conductor and is more suited for higher volume manufacturing. The signal conductor distributes thermal expansion and contraction thereof substantially throughout the portion of substantially smooth and even curvature, and the signal conductor of minimum length and of smooth and even curvature lessens impedance mismatch at a junction of the signal conductor and the RF launch area.

The common signal conductor 2 bends at both ends of the signal conductor 2 make for a reduced cable cost. Assembly and installation time is reduced, which increases manufacturing volumes, and the possibility of the signal conductor bends contacting the ground circuit conductor is eliminated.

Other embodiments and modifications of the invention are intended to be covered by the spirit and scope of the appended claims.

What is claimed is:

1. A method of making a Balun assembly comprises the steps of:
Providing a coaxial cable of precise electrical length,
Shaping an exposed signal conductor that projects from a remainder of the coaxial cable with a portion of substantially smooth and even curvature and of minimum length to project an end of the signal conductor substantially straight toward an RF launch area defined by a microstrip area on a circuit board, and
Positioning the RF launch area on the circuit board so as to directly oppose the remainder of the cable and in close proximity thereto to minimize the length of the exposed signal conductor, thereby contributing to lessened impedance mismatch, and thereby distributing thermal expansion and contraction along the portion of substantially smooth and even curvature to reduce strain on a joint between the signal conductor and the RF launch area.

2. A method as recited in claim 1, and further comprising the steps of: forming the exposed signal conductor with substantially straight portions of minimum length adjoining the portion of substantially smooth and even curvature, and thereby distributing thermal expansion and contraction of the signal conductor along the substantially straight portions and the portion of substantially smooth and even curvature.

3. A method as recited in claim 1, and further comprising the steps of: forming the remainder of the coaxial cable along a curved path, and positioning the RF launch area in axial alignment with the curved path.

4. A method as recited in claim 1, and further comprising the steps of: forming a ground circuit conductor along a curved path on the circuit board, and joining the shield of the coaxial cable to the ground circuit conductor.

5. A Balun assembly comprising: a balanced side having a microstrip on a circuit board connected to an RF launch area, and an unbalanced side having a coaxial cable that has a precise electrical length, an exposed signal conductor of the coaxial cable has a portion of substantially smooth and even curvature and of minimum length, a balanced end the signal conductor distributes thermal expansion and contraction thereof substantially throughout the portion of substantially smooth and even curvature, and the signal conductor of minimum length and of smooth and even curvature lessens impedance mismatch at a junction of the signal conductor and the RF launch area.

6. A Balun assembly as recited in claim 5 wherein, the exposed signal conductor is of minimum length and of smooth and even curvature, and the signal conductor distributes thermal expansion and contraction thereof substantially along the substantially straight portions of minimum length and the portion of substantially smooth and even curvature.

7. A Balun assembly as recited in claim 5 wherein, a remainder of the coaxial cable extends along a curved path, and the RF launch area is defined by a microstrip area on the circuit board in axial alignment with the curved path.

8. A Balun assembly as recited in claim 5 wherein, the rf launch area is directly opposite a remainder of the coaxial cable from which the exposed signal conductor projects, and the RF launch area underlies the exposed signal conductor.
